(19) United States
(12) Patent Application Publication
(10) Pub. No.: US 2023/0406142 A1
(43) Pub. Date: Dec. 21, 2023

(54) POWER TRANSMITTING APPARATUS, COMMUNICATION METHOD FOR POWER TRANSMITTING APPARATUS, AND NON-TRANSITORY COMPUTER-READABLE STORAGE MEDIUM

(71) Applicant: CANON KABUSHIKI KAISHA, Tokyo (JP)

(72) Inventor: Hidetada Nago, Hiroshima (JP)

(21) Appl. No.: 18/460,037

(22) Filed: Sep. 1, 2023

Related U.S. Application Data
(63) Continuation of application No. PCT/JP2022/007167, filed on Feb. 22, 2022.

(30) Foreign Application Priority Data
Mar. 5, 2021 (JP) 2021-035372

(51) Int. Cl. B60L 53/66; B60L 53/124; B60L 53/53; B60L 53/39

(52) U.S. Cl. CPC B60L 53/66; B60L 53/124; B60L 53/53; B60L 53/39

(57) ABSTRACT

A power transmitting apparatus wirelessly transmits power to a power receiving apparatus, and communicates with the power receiving apparatus. The power transmitting apparatus transmits, to the power receiving apparatus, a signal to request a change in a degree of modulation of a load modulation signal, which is received from the power receiving apparatus, in accordance with an amplitude of the load modulation signal.

### CROSS-REFERENCE TO RELATED APPLICATIONS

This application is a Continuation of International Patent Application No. PCT/JP2022/007167, filed Feb. 22, 2022, which claims the benefit of Japanese Patent Application No. 2021-035372, filed Mar. 5, 2021, both of which are hereby incorporated by reference herein in their entireties.

### TECHNICAL FIELD

The present disclosure relates to a power transmitting apparatus, a method for controlling a power transmitting apparatus, and a storage medium.

### BACKGROUND ART

In wireless power transmission, a load modulation method is known in which a power receiving apparatus performs amplitude modulation on transmitted power when the power receiving apparatus provides a notification to a power transmitting apparatus. PTL 1 discloses a method for transmitting test signals having different degrees of modulation at the start of power transmission and determining the degree of modulation to be used during power transmission.

### CITATION LIST

### Patent Literature

PTL 1 Japanese Patent Laid-Open No. 2008-8763

However, in PTL 1, for example, due to a factor such as an object different from the power receiving apparatus being placed in a power transmission range of the power transmitting apparatus during power transmission, there is a possibility that communication will not be appropriately performed even if the determined degree of modulation is used.

### SUMMARY

An object of the present disclosure is to suppress stopping of appropriate communication during power transmission.

A power transmitting apparatus according to an aspect of the present disclosure wirelessly transmits power to a power receiving apparatus, and communicates with the power receiving apparatus. The power transmitting apparatus transmits, to the power receiving apparatus, a signal to request a change in a degree of modulation of a load modulation signal, which is received from the power receiving apparatus, in accordance with an amplitude of the load modulation signal.

According to the present disclosure, it is possible to suppress stopping of appropriate communication during power transmission.

Further features of the present disclosure will become apparent from the following description of exemplary embodiments with reference to the attached drawings.

### BRIEF DESCRIPTION OF DRAWINGS

FIG. 1 is a diagram illustrating communication between a power transmitting apparatus and a power receiving apparatus.

FIG. 2 is a block diagram illustrating a configuration example of the power transmitting apparatus.

FIGS. 3A to 3C are diagrams illustrating communication flows between the power transmitting apparatus and the power receiving apparatus.

FIG. 4 is a diagram illustrating a configuration example of a load modulation signal modulating unit.

FIG. 5A is a diagram illustrating power transmitting coils.

FIG. 5B is a diagram illustrating the power transmitting coils.

FIG. 5C is a diagram illustrating the power transmitting coils.

FIG. 5D is a diagram illustrating the power transmitting coils.

FIG. 6A is a diagram illustrating a load modulation signal.

FIG. 6B is a diagram illustrating the load modulation signal.

FIG. 7 is a flowchart illustrating an operation of the power transmitting apparatus.

FIG. 8 is a diagram for describing phases of processing performed by the power transmitting apparatus and the power receiving apparatus.

FIG. 9 is a block diagram illustrating a configuration example of the power receiving apparatus.

### DESCRIPTION OF EMBODIMENTS

### First Embodiment

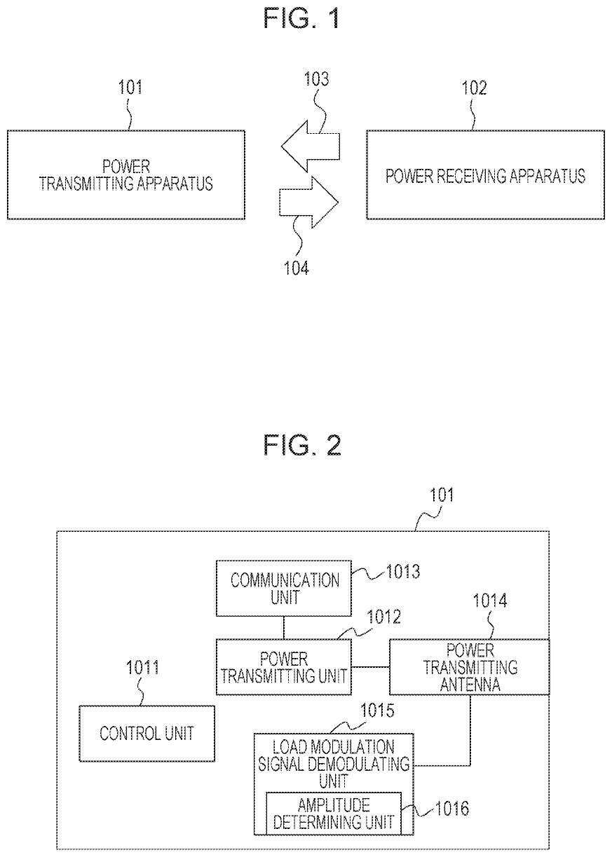

FIG. 1 is a diagram illustrating a configuration example of a power transmission system according to a first embodiment. The power transmission system includes a power transmitting apparatus 101 and a power receiving apparatus 102. The power transmitting apparatus 101 performs wireless power transmission to the power receiving apparatus 102. The wireless power transmission includes an initial phase in which authentication or the like is performed between the power transmitting apparatus 101 and the power receiving apparatus 102, and a power transmission phase in which power is transmitted. During the power transmission phase, the power receiving apparatus 102 transmits a load modulation signal 103 to the power transmitting apparatus 101.

A case where a frequency-modulated signal 104 is used for communication from the power transmitting apparatus 101 to the power receiving apparatus 102 will be described. The frequency-modulated signal 104 is used for communication from the power transmitting apparatus 101 to the power receiving apparatus 102. The load modulation signal 103 is used for communication from the power receiving apparatus 102 to the power transmitting apparatus 101. The power receiving apparatus 102 transmits the load modulation signal 103 to the power transmitting apparatus 101. The power transmitting apparatus 101 transmits the frequency-modulated signal 104 to the power receiving apparatus 102.

FIG. 2 is a block diagram illustrating a configuration example of the power transmitting apparatus 101 in FIG. 1. The power transmitting apparatus 101 includes a control unit 1011, a power transmitting unit 1012, a communication unit 1013, a power transmitting antenna 1014, and a load modulation signal demodulating unit 1015. The load modulation signal demodulating unit 1015 includes an amplitude determining unit 1016. The power transmitting apparatus 101 in FIG. 2 illustrates units related to wireless power transmission.

The control unit 1011 controls the entirety of the power transmitting apparatus 101 by, for example, executing a control program stored in a memory (not illustrated). That is, the control unit 1011 controls each of the functional units illustrated in FIG. 2. The control unit 1011 also performs control related to power transmission control in the power transmitting apparatus 101. In one example, the control unit 1011 performs control necessary for device authentication and power transmission in the power transmitting apparatus 101. The control unit 1011 may perform control for executing an application other than wireless power transmission. The control unit 1011 includes one or more processors such as a central processing unit (CPU) or a micro processing unit (MPU). Note that the control unit 1011 may be configured by hardware dedicated to specific processing, such as an application specific integrated circuit (ASIC). The control unit 1011 may include an array circuit such as a field programmable gate array (FPGA) compiled to execute predetermined processing. The control unit 1011 causes a memory (not illustrated) to store information to be stored during execution of various kinds of processing. In addition, the control unit 1011 may measure a time or a time point using a timer.

The power transmitting unit 1012 generates power to be transmitted to the power receiving apparatus 102, and wirelessly transmits the power to the power receiving apparatus 102 via the power transmitting antenna 1014. The communication unit 1013 generates the frequency-modulated signal 104 in FIG. 1 under the control of the control unit 1011. If necessary, the power transmitting unit 1012 superimposes the frequency-modulated signal 104 generated by the communication unit 1013 on the power and wirelessly transmits the signal to the power receiving apparatus 102 via the power transmitting antenna 1014. The load modulation signal demodulating unit 1015 receives the load modulation signal 103 (FIG. 1) superimposed on the transmitted power from the power receiving apparatus 102 via the power transmitting antenna 1014, and demodulates the load modulation signal 103. The load modulation signal demodulating unit 1015 outputs information obtained by demodulating the load modulation signal 103 to the control unit 1011. The load modulation signal demodulating unit 1015 includes the amplitude determining unit 1016. The amplitude determining unit 1016 determines whether the received load modulation signal 103 has an amplitude that can be demodulated.

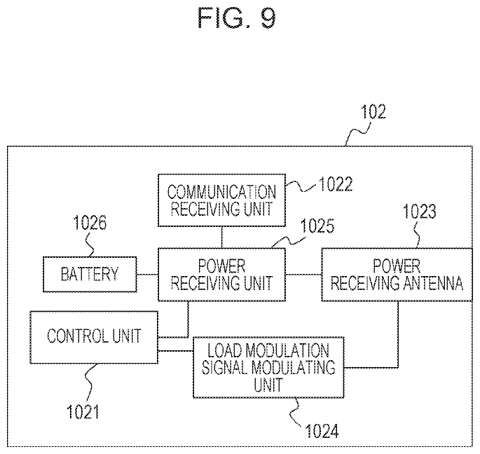

FIG. 9 is a block diagram illustrating a configuration example of the power receiving apparatus 102 in FIG. 1. The power receiving apparatus 102 includes a control unit 1021, a communication receiving unit 1022, a power receiving antenna 1023, a load modulation signal modulating unit 1024, a power receiving unit 1025, and a battery 1026. The power receiving apparatus 102 in FIG. 9 illustrates units related to wireless power transmission.

The power receiving antenna 1023 receives power wirelessly transmitted by the power transmitting apparatus 101. The power receiving unit 1025 extracts necessary direct current power from the power received by the power receiving antenna 1023, and charges the battery 1026. The communication receiving unit 1022 extracts the frequency-modulated signal 104 including control information and state information from the power received by the power receiving antenna 1023, and outputs the frequency-modulated signal 104 to the control unit 1021. Under the control of the control unit 1021, the load modulation signal modulating unit 1024 generates the load modulation signal 103 including the control information and state information of the power receiving apparatus 102, the load modulation signal 103 being addressed to the power transmitting apparatus 101, and wirelessly transmits the load modulation signal 103 to the power transmitting apparatus 101 via the power receiving antenna 1023. After the power receiving antenna 1023 receives the power transmitted by the power transmitting apparatus 101, the load modulation signal modulating unit 1024 superimposes the load modulation signal 103 on the transmitted power by controlling a load.

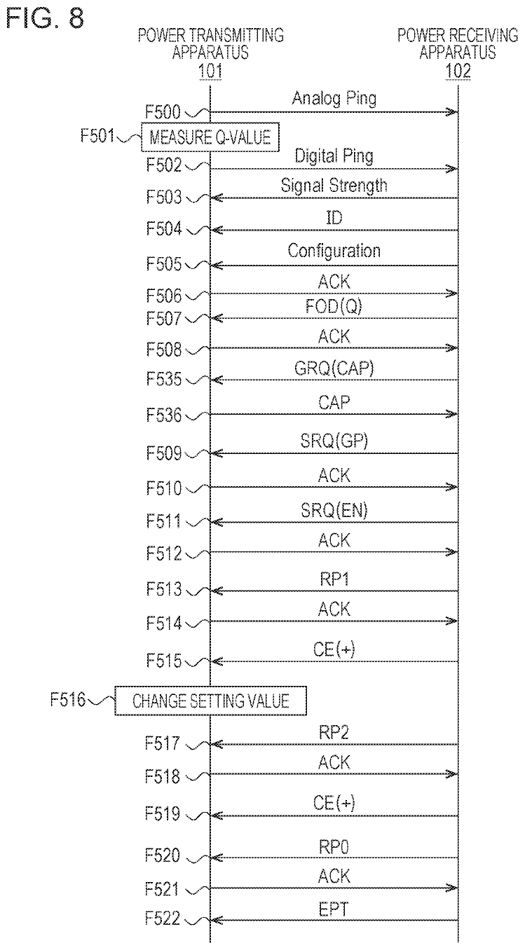

FIG. 8 is a diagram for describing processing performed by the power transmitting apparatus 101 and the power receiving apparatus 102 according to this embodiment. The power transmitting apparatus 101 and the power receiving apparatus 102 perform wireless power transmission compliant with the Wireless Power Consortium (WPC) standard. FIG. 8 is a sequence diagram illustrating a control flow of the power transmitting apparatus 101 and the power receiving apparatus 102 compliant with the WPC standard v1.2.3. The sequence illustrated in FIG. 8 is control executed not only by the power transmitting apparatus 101 including a plurality of power transmitting antennas (power transmitting coils) 1014 and a plurality of power transmitting units 1012 but also by a power transmitting apparatus having a configuration matching the WPC standard. In the following description, it is assumed that the power transmitting apparatus 101 transmits power to the power receiving apparatus 102 using a given power transmitting coil. Note that a case where the power transmitting apparatus 101 and the power receiving apparatus 102 are compliant with the WPC standard v1.2.3 will be described below, but the present disclosure is not limited to this. That is, the power transmitting apparatus 101 and the power receiving apparatus 102 may be compliant with a version of the WPC standard after the WPC standard v1.2.3, or may be compliant with a version earlier than the WPC standard v1.2.3.

The WPC standard defines a plurality of phases including a power transmission phase (Power Transfer phase) in which power transmission for charging is performed and a phase before power transmission for charging is performed. The phases before power transmission include (1) a Selection phase, (2) a Ping phase, (3) an Identification & Configuration phase, (4) a Negotiation phase, and (5) a Calibration phase. Hereinafter, the Identification & Configuration phase is referred to as I & C phase.

In the Selection phase, the power transmitting apparatus 101 transmits an Analog Ping (hereinafter, referred to as A-Ping) in order to detect an object that is present near the power transmitting coil (F500). Note that a method for controlling the A-Ping according to this embodiment will be described later. The A-Ping is a pulsed power for detecting an object. In addition, even if the power receiving apparatus 102 receives the A-Ping, the power is too small to activate the control unit 1021 of the power receiving apparatus 102. The power transmitting apparatus 101 intermittently transmits the A-Ping. The voltage or current applied to the power transmitting coil changes between a case where an object is placed in a power transmittable range of the power transmitting apparatus 101 and a case where no object is placed. Therefore, the control unit 1011 of the power transmitting apparatus 101 detects at least one of the voltage value and the current value of the power transmitting coil when the A-Ping is transmitted. The control unit 1011 of the power transmitting apparatus 101 determines that an object is present if the detected voltage value falls below a certain threshold value or if the detected current value exceeds a certain threshold value, and transitions to the Ping phase.

In the Ping phase, upon detecting placement of an object by the A-Ping, the power transmitting apparatus 101 measures a Q value (Quality Factor) of the power transmitting coil (F501). When the Q value measurement ends, the power transmitting apparatus 101 starts to transmit power of a Digital Ping (hereinafter, referred to as D-ping) (F502). The D-Ping is power for activating the control unit 1021 of the power receiving apparatus 102, and is larger than the A-Ping. After that, the power transmitting apparatus 101 continues to transmit power larger than or equal to the D-Ping after starting to transmit the power of the D-Ping (F502) until the power transmitting apparatus 101 receives an EPT (End Power Transfer) packet requesting a stop of power transmission from the power receiving apparatus 102 (F522). When activated by receiving the D-Ping, the control unit 1021 of the power receiving apparatus 102 transmits a Signal Strength packet, which is data storing the voltage value of the received D-Ping, to the power transmitting apparatus 101 (F503). The power transmitting apparatus 101 recognizes the object detected in the Selection phase as the power receiving apparatus 102 by receiving the Signal Strength packet from the power receiving apparatus 102 that has received the D-Ping. Upon receiving the Signal Strength packet, the power transmitting apparatus 101 transitions to the I & C phase.

In the I & C phase, the power receiving apparatus 102 transmits data storing an identifier (ID) including information of the version of the WPC standard with which the power receiving apparatus 102 complies and device identification information (F504). In addition, the power receiving apparatus 102 transmits, to the power transmitting apparatus 101, a Configuration packet including information indicating a maximum value of power to be supplied to a load by the power receiving unit 1025 (F505). By receiving the ID and the Configuration packet, the power transmitting apparatus 101 determines whether the power receiving apparatus 102 is a version corresponding to the WPC standard with which the power transmitting apparatus 101 complies, and transmits acknowledge (ACK). Specifically, if the power transmitting apparatus 101 determines that the power receiving apparatus 102 is compatible with an extended protocol of the WPC standard v1.2 or later (including processing in the Negotiation phase to be described later), the power transmitting apparatus 101 responds with the ACK (F506). Upon receiving the ACK, the power receiving apparatus 102 transitions to the Negotiation phase in which the power to be transmitted and received is negotiated.

In the Negotiation phase, the power receiving apparatus 102 transmits foreign object detection (FOD) Status data to the power transmitting apparatus 101 (F507). In this embodiment, the FOD Status data is referred to as FOD (Q). The power transmitting apparatus 101 performs foreign object detection based on a Q value stored in the received FOD (Q) and the Q value measured by the Q value measurement, and transmits, to the power receiving apparatus 102, an ACK indicating that it is determined that a foreign object is unlikely to be present (F508).

Upon receiving the ACK, the power receiving apparatus 102 transmits a General Request (Capability) packet, which is an inquiry about the capability of the power transmitting apparatus 101 and is one of the General Request packets defined by the WPC standard (F535). Hereinafter, the General Request (Capability) packet is referred to as GRQ (CAP) packet. Upon receiving the GRQ (CAP) packet, the power transmitting apparatus 101 transmits a Capability packet (hereinafter, referred to as CAP) storing capability information corresponding to the power transmitting apparatus 101 (F536).

The power receiving apparatus 102 negotiates a Guaranteed Power (hereinafter, referred to as GP), which is a maximum value of a power value requested to be received. Specifically, the Guaranteed Power represents the amount of power that can be used by the power receiving apparatus 102, which is agreed in the negotiation with the power transmitting apparatus 101. That is, the GP is the maximum value of power that can be used to be supplied to the load of the power receiving apparatus 102 (power to be consumed by the load). The negotiation is implemented by transmitting, to the power transmitting apparatus 101, a packet in which the value of the Guaranteed Power requested by the power receiving apparatus 102 is stored from among the Specific Request packets defined by the WPC standard (F509). In this embodiment, the data is referred to as SRQ (GP) packet.

The power transmitting apparatus 101 responds to the SRQ (GP) packet in consideration of, for example, the power transmission capability of the power transmitting apparatus 101. If it is determined that the Guaranteed Power can be accepted, the power transmitting apparatus 101 transmits an ACK indicating that the request has been accepted (F510). When the negotiation of a plurality of parameters including the Guaranteed Power ends, the power receiving apparatus 102 transmits, to the power transmitting apparatus 101, an SRQ (EN) packet to request the end of the negotiation (End Negotiation) from among the Specific Request packets (F511). The power transmitting apparatus 101 transmits an ACK in response to the SRQ (EN) packet (F512), ends the Negotiation phase, and transitions to the Calibration phase in which a reference for performing the foreign object detection based on a power loss method is created. Note that the foreign object detection is processing for determining whether an object different from the power receiving apparatus 102 (hereinafter, referred to as foreign object) is present, or whether there is a possibility that a foreign object is present, within the power transmittable range of the power transmitting apparatus 101.

In the Calibration phase, in a state in which the power receiving unit 1025 and the load (the battery 1026) are not connected to each other, the power receiving apparatus 102 notifies the power transmitting apparatus 101 of a received power value R1 when the power receiving apparatus 102 receives the D-Ping. At this time, the power receiving apparatus 102 transmits, to the power transmitting apparatus 101, a Received Power packet (model) (hereinafter, referred to as RP1) storing the received power value R1 (F513). Upon receiving the RP1, the power transmitting apparatus 101 transmits an ACK to the power receiving apparatus 102 (F514). At this time, the power transmitting apparatus 101 measures a transmitted power value T1 of the power transmitting apparatus 101, and calculates a difference Δ1 between T1 and R1, which is a power loss. After receiving the ACK, the power receiving apparatus 102 transmits, to the power transmitting apparatus 101, a Control Error packet (hereinafter, referred to as CE) to request the power transmitting apparatus 101 to increase or decrease a received power voltage, in a state in which the power receiving unit 1025 and the load are connected to each other. A sign and a numerical value are stored in the CE. If the sign of the numerical value stored in the CE is plus, it means that the received power voltage is requested to be increased. If the sign is minus, it means that the received power voltage is requested to be decreased. If the numerical value is zero, it means that the received power voltage is requested to be maintained. Here, the power receiving apparatus 102 transmits, to the power transmitting apparatus 101, a CE (+) indicating that the received power voltage is to be increased (F515).

Upon receiving the CE (+), the power transmitting apparatus 101 changes a setting value of the power transmitting unit 1012 and increases a transmitted power voltage (F516). When the received power increases in response to the CE (+), the power receiving apparatus 102 supplies the received power to the load and transmits a Received Power packet (model) (hereinafter, referred to as RP2) to the power transmitting apparatus 101 (F517). Here, the RP2 stores a received power value R2 in a state in which the power receiving apparatus 102 supplies the output of the power receiving unit 1025 to the load (the battery 1026).

Upon receiving the RP2, the power transmitting apparatus 101 transmits an ACK to the power receiving apparatus 102 (F518). At this time, the power transmitting apparatus 101 measures a transmitted power value T2 of the power transmitting apparatus 101, and calculates a difference Δ2 between T2 and R2, which is a power loss. The power transmitting apparatus 101 performs the foreign object detection based on the power losses with reference to the power loss Δ1, in a case where the power receiving unit 1025 is not connected to the load and the power consumption of the load is zero, and the power loss Δ2, in a case where the power receiving unit 1025 is connected to the load and the power consumption of the load is not zero. Specifically, the power transmitting apparatus 101 can predict a power loss in a state in which a foreign object is not present at a given received power value based on Δ1 and Δ2, and perform the foreign object detection based on the received power value actually received and the transmitted power value. Upon transmitting the ACK in response to the RP2, the power transmitting apparatus 101 transitions to the Power Transfer phase.

In the Power Transfer phase, the power transmitting apparatus 101 transmits power with which the power receiving apparatus 102 can receive a maximum of 15 watts negotiated in the Negotiation phase. The power receiving apparatus 102 transmits, to the power transmitting apparatus 101, a Received Power packet (mode0) (hereinafter, referred to as RP0), in which the CE and the current received power value are stored, on a regular basis (F519, F520). Upon receiving the RP0 from the power receiving apparatus 102, the power transmitting apparatus 101 predicts a power loss at a given received power based on Δ1 and Δ2 above, and performs the foreign object detection. If it is determined that a foreign object is unlikely to be present as a result of the foreign object detection, the power transmitting apparatus 101 transmits an ACK to the power receiving apparatus 102 (F521). If it is determined that a foreign object is likely to be present, the power transmitting apparatus 101 transmits non-acknowledge (NAK) to the power receiving apparatus 102.

When the charging of the battery 1026 ends, the power receiving apparatus 102 transmits, to the power transmitting apparatus 101, the EPT (End Power Transfer) packet requesting a stop of the power transmission (F522). The control flow of the power transmitting apparatus 101 and the power receiving apparatus 102 compliant with the WPC standard v1.2.3 is as described above.

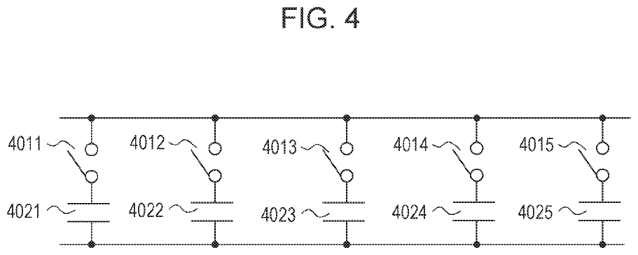

FIG. 4 is a diagram illustrating a configuration example of the load modulation signal modulating unit 1024 in FIG. 9. The load modulation signal modulating unit 1024 includes switches 4011, 4012, 4013, 4014, and 4015 and capacitors 4021, 4022, 4023, 4024, and 4025.

The load modulation signal modulating unit 1024 changes the degree of modulation of the load modulation signal 103 in FIG. 1. The capacitors 4021, 4022, 4023, 4024, and 4025 are connected to the power receiving antenna 1023 in FIG. 9 by closing the switches 4011, 4012, 4013, 4014, and 4015, respectively. The switches 4011, 4012, 4013, 4014, and 4015 can change the degree of modulation of the load modulation signal 103 in FIG. 1 by repeating opening and closing of any one or more of the switches. The capacitances of the connected capacitors 4021 to 4025 may be the same or different. This is because the total capacitance changes as a result of the number of opened/closed switches 4011 to 4015. For example, in a case where the capacitors 4021 to 4025 have the same capacitance, when a larger number of switches 4011 to 4015 are turned on, the capacitance of the load modulation signal modulating unit 1024 increases, and thus the degree of modulation increases. In addition, in a case where the capacitors 4021 to 4025 are capacitors having different capacitances, by switching the switch to be turned on and switching to a capacitor having a larger capacitance, the degree of modulation can be increased.

Although FIG. 4 illustrates an example in which the degree of modulation of the load modulation signal 103 is changed by the connection state of the capacitors 4021 to 4025, the degree of modulation can also be changed by resistors, coils, or a combination thereof. Although the capacitors 4021 to 4025 are connected in parallel in FIG. 4, the degree of modulation can be changed even in a circuit configuration in which the capacitors are connected in series and a switch is arranged to bypass each capacitor. Note that it is assumed in this embodiment that the degree of modulation increases as the capacitance of the load modulation signal modulating unit 1024 increases. However, depending on conditions such as the magnitude of received power, the degree of modulation may be increased by reducing the capacitance. In this case, the power receiving apparatus 102 switches the switch so that the capacitance of the load modulation signal modulating unit 1024 is reduced.

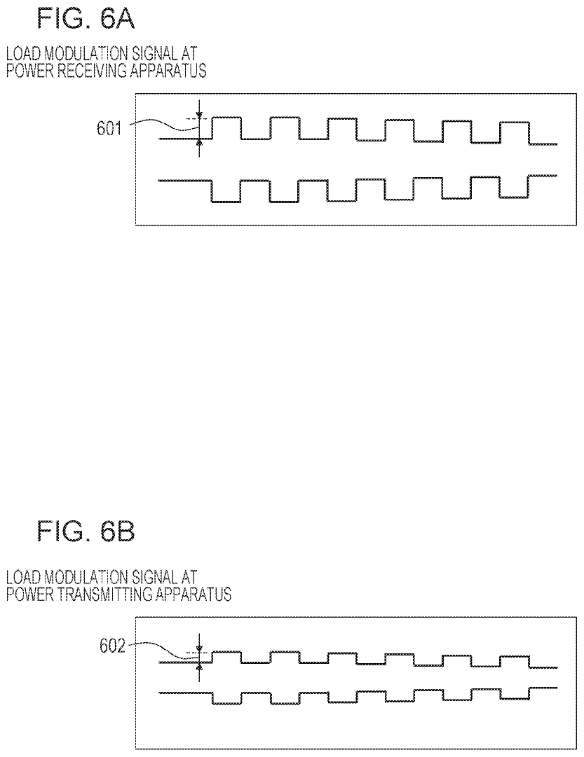

FIG. 6A is a diagram illustrating an amplitude 601 of the load modulation signal 103 transmitted by the power receiving apparatus 102. FIG. 6B is a diagram illustrating an amplitude 602 of the load modulation signal 103 received by the power transmitting apparatus 101.

FIG. 6A illustrates the amplitude 601 of the load modulation signal 103 transmitted by the power receiving apparatus 102. Subsequently, when a foreign object or the like is nearby during power transmission, the amplitude of the load modulation signal 103 changes. Due to the influence of the foreign object, the amplitude 602 of the load modulation signal 103 received by the power transmitting apparatus 101 is smaller than the amplitude 601 as illustrated in FIG. 6B. If the amplitude 602 decreases to a level at which demodulation is difficult, the amplitude 602 is not different from a fluctuating noise to the power transmitting apparatus 101.

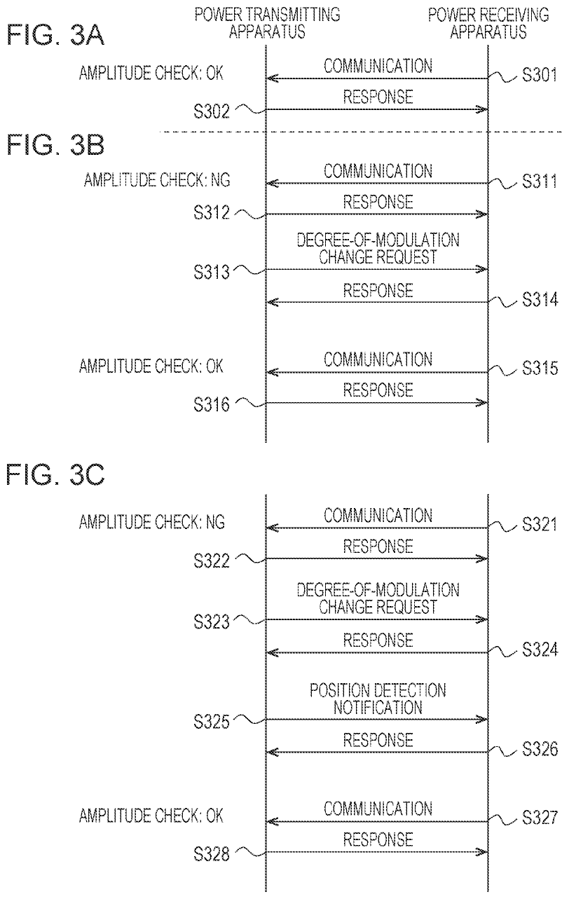

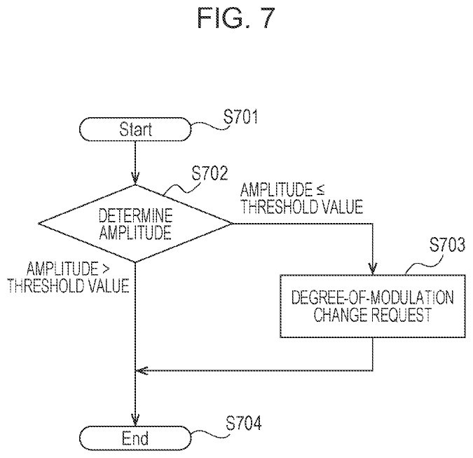

FIG. 3A is a diagram illustrating a communication flow example between the power transmitting apparatus 101 and the power receiving apparatus 102 during normal operation. FIG. 3B is a diagram illustrating a communication flow example between the power transmitting apparatus 101 and the power receiving apparatus 102 in a case where a foreign object is placed in the power transmission range of the power transmitting apparatus 101. FIG. 7 is a flowchart illustrating a method for controlling the power transmitting apparatus 101.

The following description will be given with reference to FIGS. 3A, 3B, and 7. At the start of power transmission, the power receiving apparatus 102 performs amplitude modulation of the load modulation signal 103 by repeatedly opening and closing only the switch 4011 of the load modulation signal modulating unit 1024. The “communication” in FIGS. 3A and 3B is, for example, the RP0 transmitted from the power receiving apparatus 102 to the power transmitting apparatus 101 in the power transmission phase. However, the communication is not limited to this.

FIG. 3A is a diagram illustrating a communication flow example between the power transmitting apparatus 101 and the power receiving apparatus 102 during normal operation. During normal operation, as illustrated in FIG. 3A, the control unit 1021 of the power receiving apparatus 102 transmits the load modulation signal 103 to the power receiving apparatus 102 by load modulation using the load modulation signal modulating unit 1024 (S301). In step S701, the load modulation signal demodulating unit 1015 of the power transmitting apparatus 101 receives the load modulation signal 103 via the power transmitting antenna 1014. In step S702, the amplitude determining unit 1016 of the power transmitting apparatus 101 determines whether the amplitude of the received load modulation signal 103 is larger than a threshold value. The threshold value is for determining whether the load modulation signal 103 can be demodulated. If the amplitude of the received load modulation signal 103 is larger than the threshold value, the control unit 1011 of the power transmitting apparatus 101 causes the communication unit 1013 to transmit, to the power receiving apparatus 102, a response signal to the load modulation signal 103 (S302), and proceeds to step S704. In step S704, the power transmitting apparatus 101 ends the process for the load modulation signal 103. The control unit 1021 of the power receiving apparatus 102 receives the response signal to the load modulation signal 103 by the communication receiving unit 1022.

FIG. 3B is a diagram illustrating a communication flow example between the power transmitting apparatus 101 and the power receiving apparatus 102 in a case where a foreign object is placed in the power transmission range of the power transmitting apparatus 101. For example, if the amplitude 602 of the load modulation signal 103 decreases due to placement of a foreign object in the power transmission range of the power transmitting apparatus 101, the power transmitting apparatus 101 is unable to demodulate the load modulation signal 103 from the power receiving apparatus 102. This is illustrated in FIG. 3B.

The control unit 1021 of the power receiving apparatus 102 transmits the load modulation signal 103 to the power transmitting apparatus 101 by load modulation using the load modulation signal modulating unit 1024 (S311). In step S701, the load modulation signal demodulating unit 1015 of the power transmitting apparatus 101 receives the load modulation signal 103 via the power transmitting antenna 1014. By a foreign object being placed in the power transmission range of the power transmitting apparatus 101, the amplitude 602 of the load modulation signal 103 decreases.

In step S702, the amplitude determining unit 1016 of the power transmitting apparatus 101 determines whether the amplitude of the received load modulation signal 103 is larger than the threshold value. If the amplitude of the received load modulation signal 103 is smaller than or equal to the threshold value, the control unit 1011 of the power transmitting apparatus 101 causes the communication unit 1013 to transmit, to the power receiving apparatus 102, a response signal to the load modulation signal 103 (S312), and proceeds to step S703.

In step S703, the control unit 1011 of the power transmitting apparatus 101 causes the communication unit 1013 to transmit a degree-of-modulation change request to the power receiving apparatus 102 (S313). Upon the communication receiving unit 1022 of the power receiving apparatus 102 receiving the degree-of-modulation change request, the control unit 1021 transmits, to the power transmitting apparatus 101, a response signal to the degree-of-modulation change request (S314). Subsequently, the control unit 1021 of the power receiving apparatus 102 repeatedly opens and closes the switch 4011 and the switch 4012 of the load modulation signal modulating unit 1024 at the same time to change the degree of modulation to be increased, and retransmits the load modulation signal 103 to the power transmitting apparatus 101 with the changed degree of modulation (S315). The load modulation signal demodulating unit 1015 of the power transmitting apparatus 101 receives the load modulation signal 103 via the power transmitting antenna 1014. The amplitude determining unit 1016 of the power transmitting apparatus 101 determines whether the amplitude of the received load modulation signal 103 is larger than the threshold value. If the amplitude of the received load modulation signal 103 is larger than the threshold value, the control unit 1011 of the power transmitting apparatus 101 causes the communication unit 1013 to transmit, to the power receiving apparatus 102, a response signal to the load modulation signal 103 (S316), and proceeds to step S704. In step S704, the power transmitting apparatus 101 ends the process for the load modulation signal 103.

Note that the power transmitting apparatus 101 may perform the foreign object detection after transmitting the degree-of-modulation change request to the power receiving apparatus 102. At this time, the power transmitting apparatus 101 may temporarily stop power transmission as necessary.

As described above, the power transmitting unit 1012 wirelessly transmits power to the power receiving apparatus 102. The communication unit 1013, which is a transmission unit, superimposes the signal (S313) to request a change in the degree of modulation of the load modulation signal 103 on the power and transmits the signal to the power receiving apparatus 102 if the amplitude of the load modulation signal 103 superimposed on the power and transmitted by the power receiving apparatus 102 is equal to or less than the threshold value. The signal (S313) to request a change in the degree of modulation of the load modulation signal 103 is the frequency-modulated signal 104. Upon receiving the signal (S313) to request a change in the degree of modulation of the load modulation signal 103 from the power transmitting apparatus 101, the control unit 1021 of the power receiving apparatus 102 causes the load modulation signal modulating unit 1024 to change (increase) the degree of modulation of the load modulation signal 103.

After transmission of the signal (S313), the load modulation signal demodulating unit 1015 demodulates the load modulation signal (S315) with the changed degree of modulation, which is superimposed on the power and transmitted by the power receiving apparatus 102. The degree of modulation of the load modulation signal 103 represents the difference between the maximum value (high level) and the minimum value (low level) of the load modulation signal 103 as illustrated in FIG. 6A and FIG. 6B.

Note that the control unit 1011 has an object detecting function, and may detect an object different from the power receiving apparatus 102 in the power transmission range of the power transmitting unit 1012 if the amplitude of the load modulation signal 103 superimposed on the power and transmitted by the power receiving apparatus 102 is smaller than or equal to the threshold value.

As described above, according to this embodiment, if the amplitude of the load modulation signal 103 from the power receiving apparatus 102 is smaller than or equal to the threshold value, the power transmitting apparatus 101 transmits the degree-of-modulation change request to the power receiving apparatus 102. Upon receiving the degree-of-modulation change request, the power receiving apparatus 102 increases the degree of modulation and transmits the load modulation signal 103 to the power transmitting apparatus 101 again. Thus, the power transmitting apparatus 101 can more reliably receive the load modulation signal 103 from the power receiving apparatus 102, and can perform the foreign object detection processing by detecting the possibility of the presence of a foreign object. Note that since the power receiving apparatus 102 can set the degree of modulation to a given degree before the power transmission phase, the initial degree of modulation may be set to a relatively large degree. However, according to this embodiment, there is an effect that the power transmitting apparatus 101 can detect the possibility of the presence of a foreign object by transmitting the degree-of-modulation change request. In addition, as the degree of modulation increases, noise during normal communication may also increase. Therefore, there is an effect that noise during communication is suppressed by the power receiving apparatus 102 performing communication from a state in which the degree of modulation is relatively small.

The power transmitting apparatus 101 transmits, to the power receiving apparatus 102, a signal for changing the degree of modulation of the load modulation signal 103 before the amplitude of the load modulation signal 103 reaches a level at which demodulation is difficult, and thus, the load modulation signal 103 can be prevented from becoming unable to be communicated.

### Second Embodiment

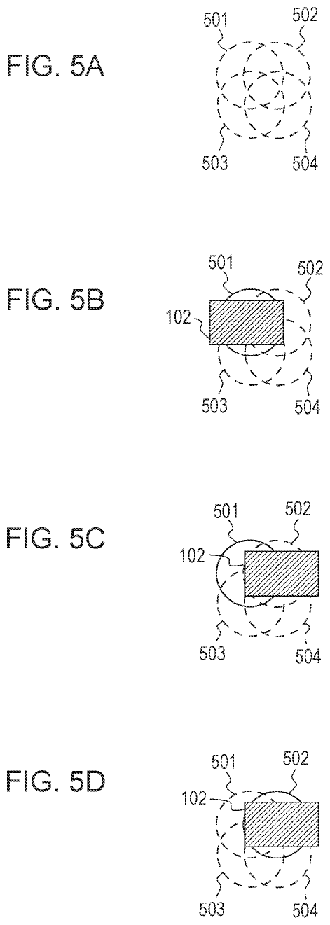

FIG. 5A is a diagram illustrating a configuration example of power transmitting coils 501 to 504 of the power transmitting apparatus 101 according to a second embodiment. A case where the power transmitting apparatus 101 includes the plurality of power transmitting coils 501 to 504 will be described. The plurality of power transmitting coils 501 to 504 are a plurality of coils. The power transmitting coil 501, the power transmitting coil 502, the power transmitting coil 503, and the power transmitting coil 504 overlap each other.

FIGS. 5B to 5D are diagrams illustrating a case where the power receiving apparatus 102 has moved relative to the power transmitting coils 501 to 504 of the power transmitting apparatus 101. The power receiving apparatus 102 moves due to an impact, for example. Among the power transmitting coils 501 to 504, the power transmitting coils indicated by broken lines are power transmitting coils that are not performing power transmission, and the power transmitting coils indicated by solid lines are power transmitting coils that are performing power transmission.

FIG. 5B indicates a state in which the power receiving apparatus 102 is placed on the power transmitting coil 501 and power transmission from the power transmitting coil 501 to the power receiving apparatus 102 is started. The power transmitting coil 501 is used for power transmission.

FIG. 5C illustrates a state in which the power receiving apparatus 102 is displaced due to an impact or the like during power transmission in FIG. 5B. The power receiving apparatus 102 is almost deviated from the power transmitting coil 501 that is performing power transmission. Therefore, as illustrated in FIG. 6B, the amplitude 602 of the load modulation signal 103 received by the power transmitting apparatus 101 from the power receiving apparatus 102 becomes small.

FIG. 3C is a diagram illustrating a communication flow example between the power transmitting apparatus 101 and the power receiving apparatus 102 when the power receiving apparatus 102 is displaced. The process illustrated in FIG. 7 is performed by the control unit 1011 executing the control program stored in a memory (not illustrated). The following description will be given with reference to FIG. 3C and FIG. 7.

The control unit 1021 of the power receiving apparatus 102 transmits the load modulation signal 103 to the power transmitting apparatus 101 by load modulation using the load modulation signal modulating unit 1024 (S321). In step S701, the load modulation signal demodulating unit 1015 of the power transmitting apparatus 101 receives the load modulation signal 103 via the power transmitting antenna 1014. By the power receiving apparatus 102 being displaced due to an impact or the like, the amplitude 602 of the load modulation signal 103 decreases.

In step S702, if the amplitude determining unit 1016 determines that the amplitude of the received load modulation signal 103 is smaller than or equal to the threshold value, the control unit 1011 of the power transmitting apparatus 101 causes the communication unit 1013 to transmit, to the power receiving apparatus 102, a response signal to the load modulation signal 103 (S322). Subsequently, the process proceeds to step S703.

In step S703, the control unit 1011 of the power transmitting apparatus 101 causes the communication unit 1013 to transmit the degree-of-modulation change request to the power receiving apparatus 102 (S323) before the load modulation signal 103 becomes unable to be demodulated. Upon the communication receiving unit 1022 of the power receiving apparatus 102 receiving the degree-of-modulation change request, the control unit 1021 transmits, to the power transmitting apparatus 101, a response signal to the degree-of-modulation change request (S324). Subsequently, the control unit 1021 of the power receiving apparatus 102 repeatedly opens and closes the switch 4011 and the switch 4012 of the load modulation signal modulating unit 1024 at the same time to change the degree of modulation to be increased. The changed degree of modulation needs to have a sufficient margin when the load modulation signal 103 is demodulated.

Since the degree-of-modulation change request has been transmitted to the power receiving apparatus 102 (S323), the control unit 1011 of the power transmitting apparatus 101 determines that the power receiving apparatus 102 is displaced, and transmits, to the power receiving apparatus 102, a position detection notification for providing a notification for detecting the position of the power receiving apparatus 102 (S325). Upon receiving the position detection notification, the control unit 1021 of the power receiving apparatus 102 transmits, to the power transmitting apparatus 101, a response signal to the position detection notification (S326).

Upon receiving the response signal to the position detection notification, the control unit 1011 of the power transmitting apparatus 101 stops power transmission and detects the position of the power receiving apparatus 102. Upon detecting the movement of the power receiving apparatus 102 to the position of the power transmitting coil 502 as a result of the detection, the control unit 1011 of the power transmitting apparatus 101 starts power transmission by using the power transmitting coil 502, as illustrated in FIG. 5D. After the power transmitting apparatus 101 detects the position, the power receiving apparatus 102 may decrease the degree of modulation by the load modulation signal modulating unit 1024 as necessary.

Subsequently, the control unit 1021 of the power receiving apparatus 102 retransmits the load modulation signal 103 to the power transmitting apparatus 101 (S327). The load modulation signal demodulating unit 1015 of the power transmitting apparatus 101 receives the load modulation signal 103 via the power transmitting antenna 1014. The amplitude determining unit 1016 of the power transmitting apparatus 101 determines whether the amplitude of the received load modulation signal 103 is larger than the threshold value. If the amplitude of the received load modulation signal 103 is larger than the threshold value, the control unit 1011 of the power transmitting apparatus 101 causes the communication unit 1013 to transmit, to the power receiving apparatus 102, a response signal to the load modulation signal 103 (S328), and proceeds to step S704. In step S704, the power transmitting apparatus 101 ends the process for the load modulation signal 103.

As described above, the control unit 1011 of the power transmitting apparatus 101 has a position detecting function, transmits the signal (S323) to request a change in the degree of modulation of the load modulation signal 103, then transmits the position detection notification (S325), and detects the position of the power receiving apparatus 102. The power transmitting unit 1012 wirelessly transmits power using a power transmitting coil corresponding to the detected position of the power receiving apparatus 102. The power transmitting coil is one or more of the plurality of power transmitting coils 501 to 504 or a moving coil in which the position of the power transmitting coil is changeable.

Note that the communication unit 1013 may superimpose a signal to request a decrease in the degree of modulation of the load modulation signal 103 on the power and transmit the signal to the power receiving apparatus 102 after starting wireless power transmission using the power transmitting coil corresponding to the detected position of the power receiving apparatus 102.

As described above, according to this embodiment, the power transmitting apparatus 101 can detect the position of the power receiving apparatus 102 and correct the displacement of the power receiving apparatus 102 relative to the power transmitting coil.

The degree-of-modulation change request transmitted by the power transmitting apparatus 101 in the first and second embodiments may have the following configuration. Specifically, the degree-of-modulation change request may be a packet for the power transmitting apparatus 101 to make some request to the power receiving apparatus 102, such as a Reserved Packet or Proprietary Packet whose Packet type is not defined among the Specific Request packets defined in the WPC standard v1.2.3.

Similarly, the degree-of-modulation change request may be a Reserved Packet or Proprietary Packet whose Packet type is not defined among the General Request packets defined in the WPC standard v1.2.3.

In addition, a packet other than the Specific Request packets or General Request packets among the packets of the WPC standard version 1.2.3 may be used for this request. For example, a Reserved Packet or Proprietary Packet whose Packet type is not defined other than the Specific Request packets or General Request packets may be used for this request.

The degree-of-modulation change request may be a request to increase the degree of modulation or a request to decrease the degree of modulation. In addition, an information element indicating that the degree of modulation is to be increased and an information element indicating that the degree of modulation is to be decreased may be stored in the data of a Specific Request packet or General Request packet.

In the above-described embodiments, the power transmitting apparatus 101 transmits the degree-of-modulation change request to the power receiving apparatus 102. However, the power receiving apparatus 102 may transmit the degree-of-modulation change request to the power transmitting apparatus 101, and the power transmitting apparatus 101 may change the degree of modulation. Specifically, if the degree of modulation (e.g., amplitude) of the received frequency-modulated signal 104 is smaller than the threshold value, the power receiving apparatus 102 may transmit the degree-of-modulation change request to the power transmitting apparatus 101. In addition, the above-described Specific Request packets or General Request packets may be used for the request. A packet other than the Specific Request packets or General Request packets among the packets of the WPC standard version 1.2.3 may be used for this request. For example, a Reserved Packet or Proprietary Packet whose Packet type is not defined other than the Specific Request packets or General Request packets may be used for this request. The degree-of-modulation change request may be a request to increase the degree of modulation or a request to decrease the degree of modulation. In addition, an information element indicating that the degree of modulation is to be increased and an information element indicating that the degree of modulation is to be decreased may be stored in the data of a Specific Request packet or General Request packet. Furthermore, although the power transmitting apparatus 101 is configured to transmit the frequency-modulated signal 104 in the above-described embodiments, this may be an amplitude-modulated signal.

It should be noted that each of the above-described embodiments is merely a specific example for carrying out the present disclosure, and the technical scope of the present disclosure is not interpreted in a limited manner by these embodiments. That is, the present disclosure can be implemented in various forms without departing from the technical idea or the main features thereof.

### OTHER EMBODIMENTS

The above-described first and second embodiments may be implemented in combination.

The power receiving apparatus and the power transmitting apparatus can have a function of executing an application other than wireless charging. An example of the power receiving apparatus is an information processing terminal such as a smartphone, and an example of the power transmitting apparatus is an accessory device for charging the information processing terminal. For example, the information processing terminal includes a display unit (display) that displays information to a user and that is supplied with power received from a power receiving coil (antenna). The power received from the power receiving coil is stored in a power storage unit (battery), and the power is supplied from the battery to the display unit. In this case, the power receiving apparatus may include a communication unit for communicating with another apparatus different from the power transmitting apparatus. The communication unit may be compatible with a communication standard such as near field communication (NFC) or the fifth generation mobile communication system (5G). Furthermore, in this case, the communication unit may perform communication by power being supplied from the battery to the communication unit. The power receiving apparatus may be a tablet terminal, a storage device such as a hard disk device or a memory device, or an information processing apparatus such as a personal computer (PC). Furthermore, the power receiving apparatus may be, for example, an imaging apparatus (a camera, a video camera, or the like). The power receiving apparatus may be an image input apparatus such as a scanner or an image output apparatus such as a printer, a copier, or a projector. The power receiving apparatus may be a robot, a medical device, or the like. The power transmitting apparatus can be an apparatus for charging the above-described device.

The power transmitting apparatus may be a smartphone. In this case, the power receiving apparatus may be another smartphone or wireless earphones.

The power receiving apparatus according to any of the above embodiments may be a vehicle such as an automobile or an automated guided vehicle (AGV). For example, an automobile serving as the power receiving apparatus may receive power from a charger (power transmitting apparatus) via a power transmitting antenna installed in a parking lot. The vehicle serving as the power receiving apparatus may receive power from a charger (power transmitting apparatus) via a power transmitting coil (antenna) embedded in a road or a traveling path. In such a vehicle, the received power is supplied to the battery. The power of the battery may be supplied to an actuation unit (a motor or an electric-powered unit) that drives the wheels, or may be used to drive a sensor used for driving assistance or to drive a communication unit that performs communication with an external apparatus. That is, in this case, the power receiving apparatus may include, in addition to the wheels, a battery, a motor and a sensor that are driven using the received power, and a communication unit that communicates with an apparatus other than the power transmitting apparatus. The power receiving apparatus may further include an accommodation unit for accommodating people. For example, the sensor may be a sensor used to measure an inter-vehicle distance or a distance to another obstacle. The communication unit may be compatible with, for example, a global position system (Global Positioning Satellite, GPS). The communication unit may also be compatible with a communication standard such as the fifth generation mobile communication system (5G). In addition, the vehicle may be a bicycle or a motorcycle. Furthermore, the power receiving apparatus is not limited to a vehicle, and may be a moving object, a flying object, or the like having an actuation unit that is driven using power stored in a battery.

The power receiving apparatus according to any of the above embodiments may be an electric tool, a home electric appliance, or the like. These devices, which are power receiving apparatuses, may include, in addition to a battery, a motor that is driven by received power stored in the battery. In addition, these devices may include a notification unit for providing a notification of the remaining amount of the battery or the like. These devices may include a communication unit for communicating with another apparatus different from the power transmitting apparatus. The communication unit may also be compatible with a communication standard such as NFC or the fifth generation mobile communication system (5G).

The power transmitting apparatus according to any of the above embodiments may be an in-vehicle charger that transmits power to a mobile information terminal device such as a smartphone or a tablet compatible with wireless power transmission in an automobile. Such an in-vehicle charger may be provided anywhere in the automobile. For example, the in-vehicle charger may be installed in a console of the automobile, or may be installed in an instrument panel (dashboard), between passenger seats, on the ceiling, or on a door. However, it is preferably installed in a place so as not to interfere with the driving. In addition, although an example in which the power transmitting apparatus is an in-vehicle charger has been described, such a charger is not limited to being disposed in a vehicle, and may be installed in a transport vehicle such as a train, an aircraft, or a ship. In this case, the charger may also be installed between passenger seats, on the ceiling, or on a door.

In addition, a vehicle such as an automobile including an in-vehicle charger may be the power transmitting apparatus. In this case, the power transmitting apparatus includes wheels and a battery, and supplies power to the power receiving apparatus via a power transmitting circuit unit or a power transmitting coil (antenna) using power from the battery.

The present disclosure can also be implemented by processing in which a program for implementing one or more functions in the above-described embodiments is supplied to a system or an apparatus via a network or a storage medium, and one or more processors in a computer of the system or the apparatus read and execute the program. In addition, the present disclosure can also be implemented by a circuit (e.g., an ASIC) that implements one or more functions.

The present disclosure is not limited to the above-described embodiments, and various changes and modifications can be made without departing from the spirit and scope of the present disclosure. Accordingly, the following claims are appended to disclose the scope of the present disclosure.

1. A power transmitting apparatus comprising:
a power transmitting unit configured to wirelessly transmit power to a power receiving apparatus; and
a communication unit configured to communicate with the power receiving apparatus, the communication unit transmitting, to the power receiving apparatus, a signal to request a change in a degree of modulation of a load modulation signal, which is received from the power receiving apparatus, in accordance with an amplitude of the load modulation signal.

2. The power transmitting apparatus according to claim 1, wherein, in a case where the amplitude of the load modulation signal is smaller than a threshold value, a signal to request a change in the degree of modulation to increase the amplitude of the load modulation signal is transmitted to the power receiving apparatus.

3. The power transmitting apparatus according to claim 1, wherein the degree of modulation of the load modulation signal is represented based on a difference between a maximum value and a minimum value of the load modulation signal received by the communication unit.

4. The power transmitting apparatus according to claim 1, further comprising
an object detecting unit configured to perform detection processing for detecting a foreign object in accordance with the amplitude of the load modulation signal which is received from the power receiving apparatus.

5. The power transmitting apparatus according to claim 1, further comprising
a position detecting unit configured to perform detection processing for detecting a position of the power receiving apparatus, wherein
the power transmitting unit transmits the power by using a power transmitting coil corresponding to the position of the power receiving apparatus detected by the position detecting unit.

6. The power transmitting apparatus according to claim 5, wherein the power transmitting coil is one or more of a plurality of coils or a moving coil whose position is changeable.

7. The power transmitting apparatus according to claim 5, wherein, after a start of wireless power transmission using the power transmitting coil corresponding to the detected position of the power receiving apparatus, a signal to request a change in the degree of modulation to decrease the amplitude of the load modulation signal is transmitted to the power receiving apparatus.

8. The power transmitting apparatus according to claim 1, wherein the signal is a frequency-modulated signal.

9. The power transmitting apparatus according to claim 1, further comprising:
a wheel; and
a battery, wherein
the power transmitting unit wirelessly transmits the power to the power receiving apparatus by using power from the battery.

10. The power transmitting apparatus according to claim 1, wherein the power transmitting apparatus is installed in a vehicle.

11. A communication method for a power transmitting apparatus, comprising:
wirelessly transmitting power to a power receiving apparatus; and
transmitting, to the power receiving apparatus, a signal to request a change in a degree of modulation of a load modulation signal, which is received from the power receiving apparatus, in accordance with an amplitude of the load modulation signal.

12. A non-transitory computer-readable storage medium storing a program for causing a computer to execute a communication method for a power transmitting apparatus comprising:
wirelessly transmitting power to a power receiving apparatus; and
transmitting, to the power receiving apparatus, a signal to request a change in a degree of modulation of a load modulation signal, which is received from the power receiving apparatus, in accordance with an amplitude of the load modulation signal.
